(19) United States
(12) Patent Application Publication
(10) Pub. No.: US 2016/0113325 A1
(43) Pub. Date: Apr. 28, 2016

(54) ELECTRONIC CIGARETTE

(71) Applicant: KIMREE HI-TECH INC, Tortola (VG)

(72) Inventor: QIUMING LIU, Huizhou City (CN)

(21) Appl. No.: 14/412,442

(22) PCT Filed: Mar. 4, 2013
(86) PCT No.: PCT/CN2013/072151

§ 371 Date: Nov. 14, 2015

(51) Int. Cl. A24F 47/00; H04R 1/02; H05B 1/02

(52) U.S. Cl. CPC A24F 47/008; H05B 1/0244; H04R 1/028

(57) ABSTRACT

An electronic cigarette comprising a housing and, arranged within the housing, an atomizer apparatus and a power supply control apparatus used for providing power supply to the atomizer apparatus and for controlling the working of same. The power supply control apparatus comprises a battery, a microphone, and a control panel. The microphone and the control panel are both arranged at one end of the battery. The microphone is adjacent to the battery. The control panel is arranged in proximity to an opening end of the housing and is adjacent to the microphone. The microphone and the control panel are insulated and separated from each other. The electronic cigarette is structurally simple and is easy and convenient to assemble.

### TECHNICAL FIELD

This invention relates to a field of electronic cigarette.

### DESCRIPTION OF BACKGROUND

A current electronic cigarette includes a cigarette-liquid cup for storing cigarette liquid, an atomization apparatus for vaporizing cigarette liquid into smoke, and a power supply control apparatus for supplying power to and controlling the work of the atomization apparatus. The power supply control apparatus comprises a battery, a microphone and a control panel. Generally, the control panel and the microphone are respectively located at either end of the battery, namely the control panel is disposed in front end of the battery while the microphone is located in a rear end of the battery. For such location arrangement, connecting wire of the control panel needs pass around the battery to connect the microphone, which is inconvenient for circuit connection, and is difficult for parts assembly, and results in lower productivity. Further, a cigarette liquid cup comprises a cup seat etc.; its inner structure is complex, which results assembly time-consuming and inconvenient.

### SUMMARY

An object of the present invention is to provide an electronic cigarette, which can be conveniently and quickly assembled.

To achieve the above object, an electronic cigarette provided in the present invention, comprises a housing, an atomization apparatus and a power supply control apparatus used for providing power supply to the atomization apparatus and for controlling the atomization apparatus working, both of which are disposed in the housing; the power supply control apparatus comprises a battery, a microphone, and a control panel. Herein the microphone and the control panel are both arranged at one end of the battery; the microphone is adjacent to the battery; the control panel is arranged in proximity to an opening end of the housing and is adjacent to the microphone; and the microphone and the control panel are insulated and separated from each other.

Herein, the microphone is accommodated in a microphone seat.

Herein, the microphone seat defines a cavity in one side thereof for accommodating the microphone; and an inner wall at an opening of the cavity forms an annular collar to separate and insulate the microphone from the control panel.

Herein, the microphone seat is made from flexible materials selected from any one of silica gel, rubber materials or EVA.

Herein, the control panel is enclosed in a protective casing.

Herein, the protective casing is a cylindrical component which is tightly engaged with an inner wall of the housing.

Herein, the protective casing can be made from any one insulating material selected from polyethylene terephthalate resin (PET), polypropylene (PP), ethylene-vinyl acetate copolymer (EVA), polypropylene copolymer (OPP), or polyolefin heat-shrinkable film (POF).

Herein, the electronic cigarette is separable, comprises an inhalation rod and a battery rod connected with each other; the inhalation rod comprises a cylindrical inhalation tube as a housing of the inhalation rod, the inhalation tube has one end thereof equipped with a mouthpiece cover and has the other end thereof equipped with a first connector to connect with the battery rod; the mouthpiece cover is inserted in an inner wall of the inhalation tube; the first connector is disposed at a connection end of the inhalation rod to the battery rod; the first connector comprises a first seat and a first pole respectively as electrodes of the first connector, and a first insulation sleeve disposed between the first seat and the first pole for insulation; the first pole is inserted in center of the first seat via the first insulation sleeve; the first seat, the mouthpiece cover and a part of the inhalation tube together encloses a cavity for storing cigarette liquid therein, the first seat and the mouthpiece cover are oppositely fitted on an inner wall of the inhalation tube at a certain interval; a liquid storage component for storing cigarette liquid and a tube for supporting the liquid storage component are arranged in the cavity, the liquid storage component is fitted and supported on outer wall of the tube.

Herein, the atomization apparatus comprises an atomizer, the atomizer is disposed in the inhalation rod; the battery, the microphone and the control panel are all disposed in the battery rod.

Herein, the atomizer comprises an electric heat wire and a liquid guide component for absorbing cigarette liquid and supporting the electric heat wire, the electric heat wire surrounds the liquid guide component; positive and negative poles of the electric heat wires are respectively connected with the first seat and the first pole, pass through the inhalation rod and then are connected with positive and negative poles of the battery in the battery rod.

Herein, a second connector is disposed at a connection end of the battery rod to the inhalation rod; the second connector comprises a second seat and a second pole as electrodes of the second connector, and a second insulation sleeve disposed between the second seat and the second pole for insulation; the second pole is inserted in center of the second seat via the second insulation sleeve; the second seat and the second pole are respectively connected positive and negative electrodes of the control panel; the first connector and the second connector are threadedly connected whereby the first seat and the second seat contact each other while the first pole and the second pole contact each other; Herein, the tube is a hollow circular tube with a center air vent therethrough, comprises a top end and a bottom end; the top end contacts the mouthpiece cover, the bottom end contacts the first insulation sleeve and mounted on the first pole, the first pole is inserted and fixed in the tube; the mouthpiece cover and the first pole define air passage in center thereof, the air vent of the tube is respectively communicated with the air passage of the mouthpiece to the air passage of the first pole; the tube defines slots through its lateral wall for supporting and fixing the liquid guide component, the liquid guide component goes across in the tube with both ends thereof respectively passing through the slots and then contacting the liquid storage component to absorb cigarette liquid for the electric heat wire to vaporize.

Herein, the liquid storage component is a hollow cylinder, is fitted on the outer wall of the tube and tightly engaged with the outer wall of the tube so as to be supported, and an inner wall of the liquid storage component contacts the liquid guide component.

Herein, a penetrative component is provided between the liquid storage component and the liquid guide component.

Herein the penetrative component is cylindrically shaped; an outer wall and an inner wall of the penetrative component respectively contact the liquid storage component and the liquid guide component.

According to above technical protocols, the present invention has advantages as: firstly, the microphone and the control panel are assembled at front end of the battery, which simplifies operation, prompts productivity; the collar at the opening of the microphone seat is capable of preventing short circuit between the metal at a periphery of the microphone and the control panel; the control panel is enclosed by a soft protective sleeve, which effectively prevents short circuit it contacts the microphone. Furthermore, the first seat, the mouthpiece cover and a part of the inhalation tube together enclose the cavity for storing cigarette liquid, which replaces the traditional cigarette liquid cup, and an inner structure of the electronic cigarette is simple, the assembly of the electronic cigarette can be conveniently and quickly assembled.

The present invention is further described in detail in accordance with the following embodiments together with the drawings.

### DESCRIPTION OF THE DRAWINGS

FIG. 1 is a front view of an electronic cigarette in accordance with an embodiment of the present invention.

FIG. 2 is a cross-sectional view of an inhalation rod of the electronic cigarette in accordance with the embodiment of the present invention.

FIG. 3 is a cross-sectional view of a battery rod of the electronic cigarette in accordance with the embodiment of the present invention.

FIG. 4 is an exploded view of a microphone seat of the electronic cigarette in accordance with the embodiment of the present invention.

FIG. 5 is cross-sectional view of the microphone seat of the electronic cigarette in accordance with the embodiment of the present invention.

### DETAILED DESCRIPTION OF THE EMBODIMENTS

It should be note that, no case of conflict, the embodiments and characters in the embodiments can be combined each other, the present utility model is further explained in detail in accordance with the embodiments together with the drawings.

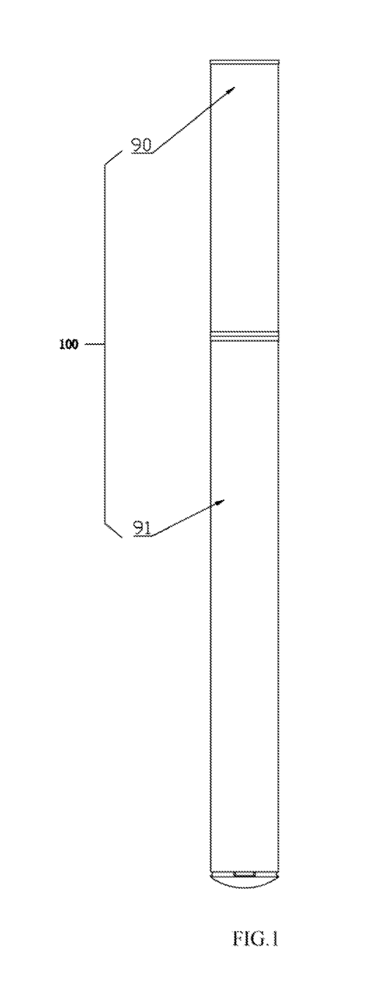

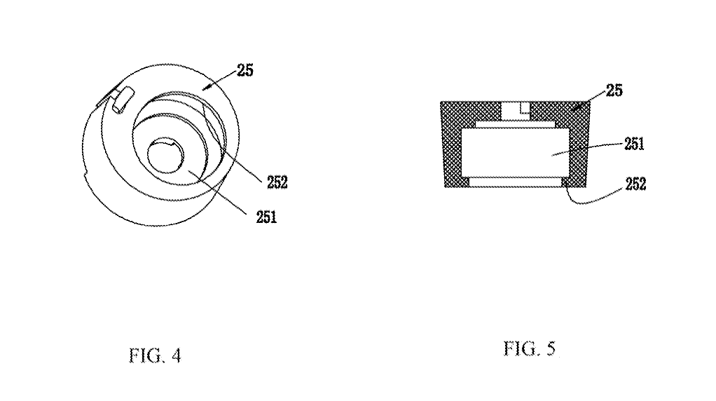

Referring to FIGS. 1 to 5, an electronic cigarette 100 is provided in accordance with the embodiment of the present invention. The electronic cigarette 100 is a separable-type electronic cigarette, comprises an inhalation rod 90 and a battery rod 91, both of which are assembled into a whole by threads connection. A housing of the electronic cigarette comprises an inhalation tube 1 as a housing of the inhalation rod 90 and a sleeve 910 as a housing of the battery rod 91. A first connector 5 is provided to a connection end of the inhalation rod 90 to the battery rod 91, a second connector 6 is provided to a connection of the battery rod 91 to the inhalation rod 90. Convenience of description will be based on a direction as shown in FIG. 1 in this embodiment.

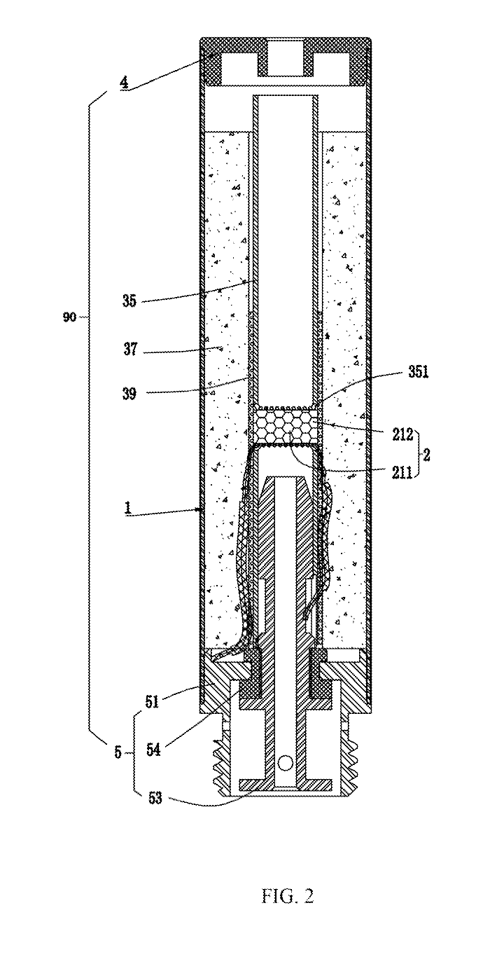

Referring to FIG. 2, in this embodiment, the inhalation rod 90 comprises the hollow cylindrical inhalation tube 1, an atomizer 21 vaporizing cigarette liquid into mist, a liquid storage part 37 for storing cigarette liquid, a mouthpiece cover 4, and the first connector 5 connected with one end of the battery rod 91. The mouthpiece cover 4 and the first connector 5 are respectively disposed at either end of the inhalation tube 1, and the atomizer 21 and the liquid storage part 37 are disposed in the inhalation tube 1.

Referring to FIG. 2, the first connector 5 comprises a first seat 51, a first pole 53 and a first insulation sleeve 54, and the first pole 53 defines air passage through it center. The first pole is fitted in the first insulation sleeve 54, the first pole 53 is inserted in the first seat 51 by the first insulation sleeve 54, and the first pole 53 and the first insulation sleeve 54 constitute a first pole assembly. In this embodiment, the first seat 51 and the first pole 53 are used as two connection electrodes of the first connector 5. The first seat 51 has a shape adapted to the inhalation tube 1, it is inserted into and fitted in the inhalation tube 1 and abuts against the cup seat 31.

The housing of the electronic cigarette is equipped with an atomization apparatus for vaporizing cigarette liquid cup into mist and a power supply control apparatus for supplying power to and control the work of the atomization apparatus 2, and the atomizer 21 is a part of the atomization apparatus. The power supply control apparatus comprises a battery 918 which will be described in following, a control panel 22 for controlling the work of the atomization apparatus and a microphone 24, the control panel 22 and the microphone 24 are all disposed at one end of the battery 918, the microphone 24 is near the battery 918, the control panel 22 is disposed near an opening of the electronic cigarette housing and is adjacent to the microphone 24 with insulation from each other.

The atomization apparatus comprises the atomizer 21; the atomizer 21 comprises electric heat wire 211 and a liquid guide component 212 for supporting the electric heat wire 211, the electric heat wire 211 winds around the liquid guide component 212. The liquid guide component 212 is capable of absorbing and storing cigarette liquid, and can be made from glass fiber or materials capable of absorbing and storing cigarette liquid, such as cotton materials. In this embodiment, the liquid guide component 212 is fitted on a tube 35 to be described below. Both ends of the electric heat wire 211 are respectively connected with the first seat 51 and the first pole 53, and then are connected with a positive electrode and a negative electrode of the battery 918 in the battery rod 91. In this embodiment, the atomizer 21 is disposed in the inhalation tube 1, while the control panel 22 and the microphone 24 are disposed in the battery rod 91, the control panel 22 is provided with a miniature pneumatic switch to control the circuit connection so as to start the electric heat wire 211. The control panel 22 is mounted in a protective casing 23, the protective casing 23 is cylindrical, is tightly fitted in the inner wall of the housing of the electronic cigarette. The protective casing 23 is made from any one insulating material selected from polyethylene terephthalate resin (PET), polypropylene(PP), ethylene-vinyl acetate copolymer (EVA), polypropylene copolymer (OPP), or polyolefin heat-shrinkable film (POF). The microphone 24 is mounted in a microphone seat 25, the microphone seat 25 has one side thereof defined a cavity 251 for accommodating the microphone 24. An annual collar 252 is formed from the inner wall at an opening of the cavity 251 to separate and insulate the microphone 24 from the circuit panel 22. The microphone seat 25 can be made from soft plastic materials, for instance, can be made from any one of the following plastic, silica gel or rubber materials: ABS, PC, PE, POM, PP, PE, PVC, TPU, TPR, TPE, or TPV. Preferably flexible plastic material with a certain desired rigidity is used.

As shown in FIG. 2, in this embodiment, the first seat 51, mouthpiece cover 4 and a part of the inhalation tube 1 together enclose a confined space like a traditional cigarette liquid cup for cigarette liquid; the first seat 51 and the mouthpiece cover 4 are fitted in an inner wall of the inhalation tube 1 with an certain interval therebetween. The liquid storage component 37 and the tube 35 for supporting the liquid storage component are provided in the confined space, and the liquid storage component 37 is fitted on the tube 35 and disposed between the cup seat 31 and the mouthpiece cover 4.

The mouthpiece cover 4 is inserted in the inhalation tube 1 and is tightly fitted on the inner wall of the inhalation tube 1 with its lateral wall; and the mouthpiece cover 4 axially defines an air vent therethrough. When the cigarette liquid in the liquid storage component 37 is exhausted, the mouthpiece cover 4 is capable of being removed to refill cigarette liquid into the cigarette liquid cup 3.

The tube 35 is used for supporting the liquid storage component 37, and is used for controlling the height of the cigarette liquid cup 3 and for supporting the liquid guide component 212, and is further used for a passage extending to an outside of the inhalation tube 1 for the mist from the cigarette liquid vaporized by the atomizer 2. In this embodiment, the tube 35 is a hollow circular tube with an air vent through its center, is made from plastic or fiber material, such as glass fiber tube, it comprises a top end and a bottom end, its top end contacts the mouthpiece cover 4 while its bottom end contacts the first insulation sleeve 54 and is mounted on the first pole 53, namely, the first pole 53 is inserted and fixed in the tube 35. The air vent of the tube 35 is respectively communicated with the air vent in the mouthpiece cover and the air passage in the first pole 53. The tube 35 defines slots 351 through its tube wall for supporting and fixing the liquid guide component 212, the liquid guide component 212 goes across the tube 35 therein with both ends thereof respectively through the slots 351 and then contacting the liquid storage component 37 to absorb the cigarette liquid for the electric heat wire 211 to vaporize.

The liquid storage component 37 is used for absorbing and storing cigarette liquid for the atomizer 2 to vaporize the cigarette liquid, and is made from materials capable of absorbing and storing liquid such as cotton materials. The liquid storage component 37 is a hollow cylinder, is fitted on outer wall of the tube 35 and is tightly engaged with and supported by the outer wall of the tube 35. The inner wall of the liquid storage component 37 contacts the liquid guide component 212. The cigarette liquid permeates and is absorbed in the liquid guide component 212 from the liquid storage component 37 for the electric heat wire 211 to vaporize the cigarette liquid into mist.

A penetrative component 39 is further provided between the liquid storage component 37 and the liquid guide component 212. The penetrative component 39 is cylindrically shaped; an outer wall and an inner wall of the penetrative component 39 respectively contact the liquid storage component 37 and the liquid guide component 212. The liquid storage component 37, the penetrative component 39, and the liquid guide component 212 have a capability of absorbing cigarette liquid increasably.

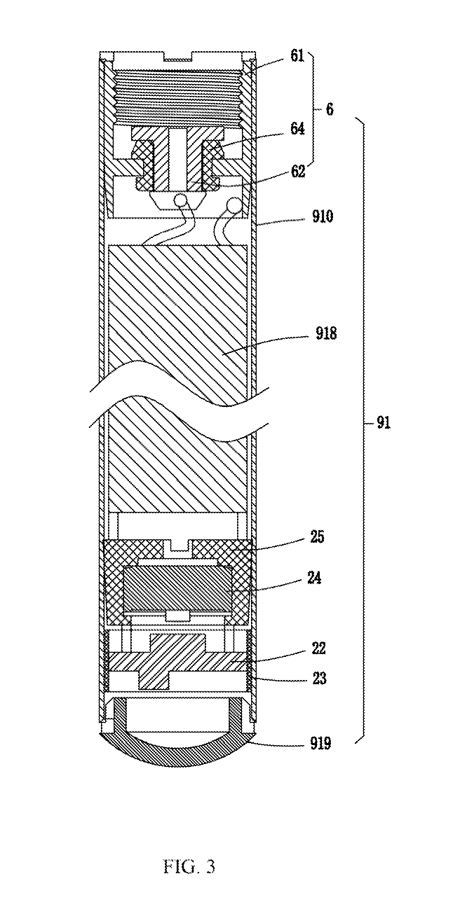

As shown in FIG. 3, the battery rod 91 substantially has a cylindrical shape, comprises a sleeve 910, the second connector 6 connected with the first connector 5 is provided to the connect end of the sleeve 910 to the inhalation rod 90, and the battery 918 is disposed in the sleeve 910. The battery rod 91 is equipped with an end cover 919 at another end thereof The end cover 919 defines an air inlet (not shown). The second connector 6 comprises a second seat 61 and a second pole assembly disposed in the second seat 61. The second pole assembly comprises a second pole 62 and a second insulation sleeve 64 disposed between the second seat 61 and the second pole 62 to insulate the second seat 61 from the second pole 62. The second pole 62 axially defines air passage through its center. The second seat 61 and the second pole 62 are respectively connected with the corresponding electrodes of the atomization control panel 22, and the atomization control panel 22 is then connected with the positive and negative poles of the battery 918.

When the first connector 5 of the inhalation rod 90 is inserted into the second connector 6 in place, the first seat 51 is inserted in the second seat 61 and contacts an end face of the second seat 61 thus the first seat 51 and the second seat 61 is electrically connected; an end face of the first pole 53 presses against the second pole 63 which ensures that the first pole 53 and the second pole 622 well contact; in such way that the first connector 5 and the second connector 6 are well connected, thereby the circuit in the inhalation rod 90 and the circuit in the battery rod 91 are correspondingly connected. Environmental air enters the battery rod 91 through the air inlet in the end cover 919 of the battery rod 91, passes the air passages in center of the second pole 622 and the first pole 53 then enters the inhalation rod 90, and then from the air passage in the first pole 53 through the air vent of the tube and the air vent of the mouthpiece cover 4 flows to outside of the inhalation rod 90, which forms passageway in the electronic cigarette, thereby air flows free from inner to outside of the electronic cigarette. Of course, environmental air may enter the inhalation rod 90 directly through the air vent of the mouthpiece cover 4 and then into the tube 35.

The above-mentioned is only the embodiments of the present invention, but not be limited thereto. It should be noted, for the persons of ordinary skill in this field, modifications, decorations, replacements, corporations, or simplifications within the spirit of the present invention can be made, which should be seemed to be included in the claimed scope of this invention.

1. An electronic cigarette comprising a housing, an atomization apparatus and a power supply control apparatus used for providing power supply to the atomization apparatus and for controlling the atomization apparatus working, both of which are disposed in the housing; the power supply control apparatus comprising a battery, a microphone, and a control panel; wherein the microphone and the control panel are both arranged at one same end of the battery; the microphone is adjacent to the battery; the control panel is arranged in proximity to an opening end of the housing and is adjacent to the microphone; the microphone and the control panel are insulated and separated from each other.

2. The electronic cigarette as described in claim 1, wherein the microphone is accommodated in a microphone seat.

3. The electronic cigarette as described in claim 2, wherein the microphone seat defines a cavity in one side thereof for accommodating the microphone; and an annular collar forms at an opening of the cavity to separate and insulate the microphone from the control panel.

4. The electronic cigarette as described in claim 2, wherein the microphone seat is made from flexible materials selected from silica gel, rubber materials or ethylene-vinyl acetate copolyme (EVA).

5. The electronic cigarette as described in claim 1, wherein the control panel is enclosed in a protective casing.

6. The electronic cigarette as described in claim 5, wherein the protective casing is a cylindrical component which is tightly fitted in an inner wall of the housing.

7. The electronic cigarette as described in claim 5, wherein the protective casing can be made from at least one insulating material selected from polyethylene terephthalate resin, polypropylene, ethylene-vinyl acetate copolymer, polypropylene copolymer, or polyolefin heat-shrinkable film.

8. The electronic cigarette as described in claim 1, wherein the electronic cigarette is separable, comprises an inhalation rod and a battery rod connected with each other; the inhalation rod comprises a cylindrical inhalation tube as a housing of the inhalation rod, the inhalation tube has one end thereof equipped with a mouthpiece cover and has the other end thereof equipped with a first connector to connect with the battery rod; the mouthpiece cover is inserted in the inhalation tube; the first connector is disposed at a connection end of the inhalation rod to the battery rod; the first connector comprises a first seat and a first pole respectively as electrodes of the first connector, and a first insulation sleeve disposed between the first seat and the first pole for insulation; the first pole is inserted in center of the first seat via the first insulation sleeve; the first seat, the mouthpiece cover and a part of the inhalation tube together encloses a cavity for storing cigarette liquid, the first seat and the mouthpiece cover are oppositely fitted on an inner wall of the inhalation tube at a certain interval; a liquid storage component for storing cigarette liquid and a tube for supporting the liquid storage component are arranged in the cavity, the liquid storage component is fitted and supported on an outer wall of the tube.

9. The electronic cigarette as described in claim 8, wherein the atomization apparatus comprises an atomizer, the atomizer is disposed in the inhalation rod; the battery, the microphone and the control panel are disposed in the battery rod.

10. The electronic cigarette as described in claim 9, wherein the atomizer comprises an electric heat wire and a liquid guide component for absorbing cigarette liquid and supporting the electric heat wire, the electric heat wire surrounds the liquid guide component; positive and negative poles of the electric heat wires are respectively connected with the first seat and the first pole, pass through the inhalation rod and then are connected with positive and negative poles of the battery in the battery rod.

11. The electronic cigarette as described in claim 9, wherein a second connector is disposed at a connection end of the battery rod to the inhalation rod; the second connector comprises a second seat and a second pole as electrodes of the second connector, and a second insulation sleeve disposed between the second seat and the second pole for insulation; the second pole is inserted in center of the second seat via the second insulation sleeve; the second seat and the second pole are respectively connected positive and negative electrodes of the control panel; the first connector and the second connector are threadedly connected whereby the first seat and the second seat contact each other while the first pole and the second pole contact each other.

12. The electronic cigarette as described in claim 10, wherein the tube is a hollow circular tube with an air vent, comprises a top and a bottom; the top contacts the mouthpiece cover, the bottom contacts the first insulation sleeve and mounted on the first pole, the first pole is inserted and fixed in the tube; the mouthpiece cover and the first pole define air passage therein, the air vent of the tube is respectively communicated with the air passage of the mouthpiece to the air passage of the first pole; the tube defines slots through its lateral wall for supporting and fixing the liquid guide component, the liquid guide component goes across in the tube with both ends thereof respectively passing through the slots and then contacting the liquid storage component to absorb cigarette liquid for the electric heat wire to vaporize.

13. The electronic cigarette as described in claim 10, wherein the liquid storage component is a hollow cylinder, is fitted on the outer wall of the tube and tightly engaged with the outer wall of the tube so as to be supported, and an inner wall of the liquid storage component contacts the liquid guide component.

14. The electronic cigarette as described in claim 10, wherein a penetrative component is provided between the liquid storage component and the liquid guide component.

15. The electronic cigarette as described in claim 14, wherein the penetrative component is cylindrically shaped, an outer wall and an inner wall of the penetrative component respectively contact the liquid storage component and the liquid guide component.

16. The electronic cigarette as described in claim 14, wherein the liquid storage component, the penetrative component, and the liquid guide component have an increased capability of absorbing cigarette liquid.
